(19) United States
(12) Patent Application Publication
(10) Pub. No.: US 2002/0151285 A1
(43) Pub. Date: Oct. 17, 2002

(54) Method for selecting to activate personal digital assistant or mobile phone in electronic device

(76) Inventors: Cheng-Shing Lai, Taipei Hsieng (TW); Jing-Song Wu, Taipei Hsieng (TW)

Correspondence Address: BACON & THOMAS, PLLC, 625 Slaters Lane 4th Floor, Alexandria, VA, 22314-1176, US

(21) Appl. No.: 09/835,366

(22) Filed: Apr. 17, 2001

(51) Int. Cl. H04B 1/00

(52) U.S. Cl. 455/140; 455/556; 455/566

(57) ABSTRACT

A method for selecting to activate personal digital assistant (PDA) or mobile phone in an electronic device is disclosed. The device is operable to select to activate PDA or mobile phone. When the device is enabled, user can select to activate PDA or mobile phone through a menu. Thus a desired PDA or mobile phone is activated for use after the selection. By utilizing this, user may select to activate PDA or mobile phone in the device, thereby preventing from violating flight safety rules by unintentionally turning on mobile phone while taking an airplane. Further, such option can greatly enhance the adaptability of the electronic device, thus attracting more people to use it.

### FIELD OF THE INVENTION

The present invention relates to personal digital assistant and mobile phone, and more particularly to a method for selecting to activate personal digital assistant or mobile phone in electronic device with improved characteristics.

### BACKGROUND OF THE INVENTION

The sale of electronic device incorporating personal digital assistant (PDA) and mobile phone has been boomed recently. In one aspect, people use such electronic device as memorandum for helping people remember addresses of friends (or customers) and itinerary, translator machine, calculator, etc. In another aspect, people use such electronic device as a typical mobile phone. Such electronic device has become an indispensable part of people's daily life. This is true as advertisement of the electronic device seen everywhere. Conventionally, PDA and mobile phone options are concurrently activated automatically when the electronic device is enabled. This eliminates the inconvenience of manually opening PDA or mobile phone. However, the previous design suffered from a disadvantage. For example, a user may only want to use PDA option of the electronic device while on an airplane. But as stated above, both PDA and mobile phone options are concurrently activated automatically when the electronic device is enabled. This obviously violates flight safety rules (i.e., mobile phone is not allowed to use while taking an airplane). It really bothers user. Thus improvement exists.

### SUMMARY OF THE INVENTION

It is an object of the present invention to provide a method for selecting to activate personal digital assistant (PDA) or mobile phone in an electronic device. The device is operable to select to activate PDA or mobile phone option. When the device is enabled, user may select to activate PDA or mobile phone option through a menu. Thus a desired PDA or mobile phone option is activated for use after the selection. By utilizing this, user may select to activate PDA or mobile phone in the device, thereby preventing from violating flight safety rules by unintentionally turning on mobile phone while taking an airplane. Further, such option can greatly enhance the adaptability of the electronic device, thus attracting more people to use it.

The above and other objects, features and advantages of the present invention will become apparent from the following detailed description taken with the accompanying drawings.

### BRIEF DESCRIPTION OF THE DRAWINGS

FIG. 1 is a block diagram illustrating components of an electronic device having the capability of permitting user to select to activate personal digital assistant or mobile phone according to the invention; and

FIG. 2 is a flow chart illustrating the process of selecting to activate personal digital assistant or mobile phone in the FIG. 1 electronic device according to the invention.

### DETAILED DESCRIPTION OF THE PREFERRED EMBODIMENTS

An electronic device for permitting user to select to activate personal digital assistant (PDA) or mobile phone according to the invention will now be described. In recent years, portable slim mobile phones have become dominant in the market. Further, there is a trend of incorporating features of other conventional electronic device into such mobile phone to form a multi-functional mobile phone. For example, PDA may be incorporated into a typical mobile phone to form a mobile phone with PDA feature. Further, a modem may be incorporated into a typical mobile phone to form a mobile phone capable of connecting to the Internet. The invention is provided by taking advantage of such trend as detailed below.

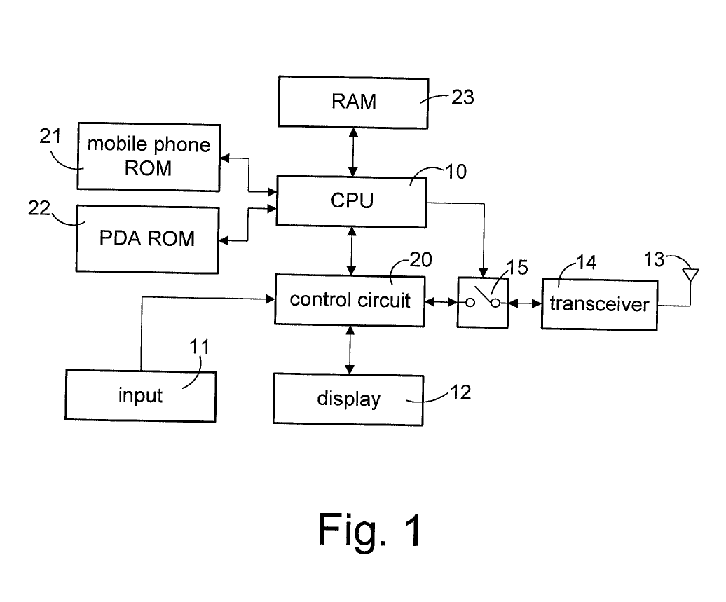

Referring to FIG. 1, there is shown an electronic device operable to select to activate PDA or mobile phone option. When electronic device is enabled, user may select to activate PDA or mobile phone option through a menu. Then a signal indicating an activated PDA or mobile phone is generated after selecting the desired PDA or mobile phone from the menu. Next the signal is sent to a central processing unit (CPU) 10 of electronic device. Thus, the desired PDA or mobile phone option is activated for use under the control of CPU 10.

Referring to FIG. 1 again, the electronic device of the invention comprises CPU 10 for controlling the operation of electronic device, an input means 11 for inputting messages, a display means 12 for showing messages, an antenna 13 for receiving and transmitting messages, and a transceiver means 14 for transmitting/receiving voice messages. All of above components are in communication with CPU 10 through a control circuit 20. Hence, CPU 10 may be activated by an operating program stored in mobile phone read only memory (ROM) 21 to close a switch means 15 so as to command transceiver means 14. CPU 10 may also be activated by an operating program stored in PDA ROM 22 to command all of above components. Further, data stored in random access memory (RAM) 23 may be read by CPU 10 or written into RAM 23 from CPU 10. In one aspect of the invention, electronic device is operable to select to activate PDA or mobile phone option by performing above components thereof. Hence, when CPU 10 is commanded to activate control circuit 20 and associated components, user may select to activate PDA or mobile phone option.

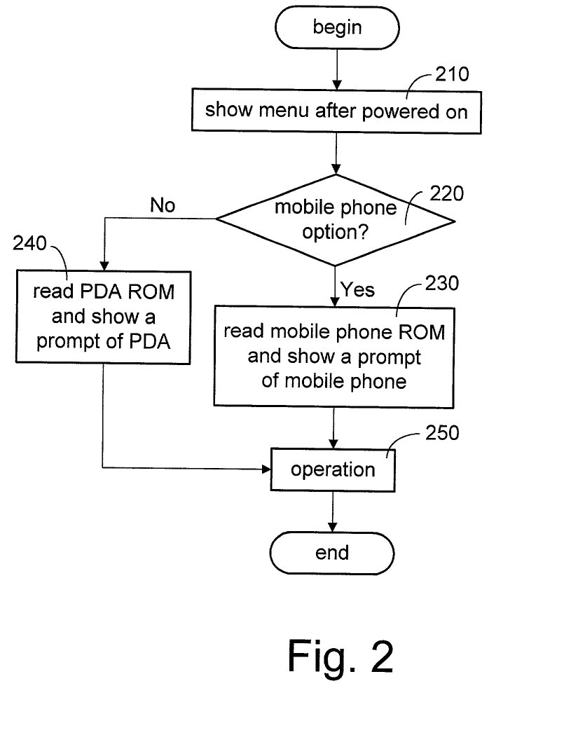

Referring to FIG. 2, a process of selecting to activate PDA or mobile phone in electronic device according to the invention will now be described. First in step 210, a menu containing two options is shown on screen for selection since display means 12 is activated after powered on. Thus user may select one of the options by clicking through the activated input means 11. In step 220, a determination is made by CPU 10 whether the mobile phone option is selected. If yes, the process goes to step 230. If not, the process goes to step 240. In step 230, CPU 10 reads an operating program stored in mobile phone ROM 21 for showing a prompt of mobile phone. Then CPU 10 closes switch means 15 so as to command transceiver means 14 through the control circuit 20. Thus, messages are transmitted from antenna 13 or received by antenna 13. The process goes to step 250. In step 240, CPU 10 is activated by an operating program stored in PDA ROM 22 for showing a prompt of PDA. At this time, the selected PDA option is under the control of control circuit 20. The process then goes to step 250. In step 250, user may operate the electronic device for reading data from RAM 23 or writing data into RAM 23.

By utilizing this, user may select to activate PDA or mobile phone in an electronic device, thereby eliminating the drawback of violating flight safety rules by unintentionally turning on mobile phone while taking an airplane in the prior art. Further, such option can greatly enhance the adaptability of electronic device, thus attracting more people to use it.

While the invention has been described by means of specific embodiments, numerous modifications and variations could be made thereto by those skilled in the art without departing from the scope and spirit of the invention set forth in the claims.

What is claimed is:

1. A method for selecting to activate a personal digital assistant (PDA) or a mobile phone in an electronic device comprising a menu containing a PDA option and a mobile phone option such that when said device is enabled, said PDA or said mobile phone option is selectable for generating a signal indicating said selection, and a central processing unit (CPU) for showing a prompt of said selected PDA option or said mobile phone option for use after receiving said signal.

2. The method of claim 1, comprising the steps of:
(a) displaying a menu containing a PDA option and a mobile phone option for selection by activating a display means after powered on;
(b) selecting one of said options by clicking through an activated input means; and
(c) determining by said CPU which of said PDA option and said mobile phone option is selected and if said mobile phone option is selected, said CPU reading a program stored in a mobile phone read only memory (ROM) for showing a prompt of said mobile phone, closing a switch means for commanding a transceiver means through a control circuit, transmitting messages from an antenna or received by said antenna, and operating said device for reading data from a random access memory (RAM) or writing data into said RAM.

3. The method of claim 2, further comprising the step of:
(d) said CPU reading a program stored in a PDA ROM if said PDA option is selected for showing a prompt of said PDA, controlling said selected PDA option by said control circuit, and operating said device for reading data from said RAM or writing data into said RAM.
